(19) United States
(12) Patent Application Publication
(10) Pub. No.: US 2017/0024110 A1
(43) Pub. Date: Jan. 26, 2017

(54) VIDEO EDITING ON MOBILE PLATFORM

(71) Applicant: Funplus Interactive, George Town (KY)

(72) Inventors: Ziqiang Xu, Belmont, CA (US); Solomon English, Seattle, WA (US); Dawei Lu, Fremont, CA (US)

(21) Appl. No.: 14/806,562

(22) Filed: Jul. 22, 2015

(51) Int. Cl. G06F 3/0484; G06F 17/24; G06F 3/16; H04N 9/802; G06F 3/0481; G06F 17/21; G11B 27/036; G06F 3/0488; G06F 3/0482

(52) U.S. Cl. CPC G06F 3/04845; G06F 3/04883; G06F 3/04847; G06F 17/24; G06F 3/04842; G06F 3/165; G06F 3/0482; G06F 3/04817; G06F 17/214; G11B 27/036; H04N 9/802

(57) ABSTRACT

A software application for a touchscreen enabled, processor operated mobile device for improving the ease of editing video files. The application including a home screen enabling user to access several editing suites, each editing suite comprising a single interface screen. Editing suites functionality including, audio editing, text editing, picture editing, camera effect editing, and others. Audio editing specifically including the functionality to select one or more songs to augment a video file, choose a portion of each song, and choose a temporal segment in the video file to augment with the portion of the song.

### TECHNICAL FIELD

Embodiments of the invention relate to the use of touchscreen interfaces to edit video files. The embodiments more particularly relate to the use of incorporating supplemental media elements into a first media file.

### BACKGROUND

During the development of the Internet age, Internet users have desired to share media files with their friends. With the inception online video streaming services, these media files increasingly shifted to a video format. As the popularity of shared videos has risen, there has been an increasing desire to add complexity to the shared videos. Prior video file editing systems and programs are complicated, non-intuitive, expensive, and resource intensive, or alternatively do not provide sufficient functionality.

### BRIEF DESCRIPTION OF THE DRAWINGS

FIG. 1 is a block diagram of a touchscreen-enabled, processor-operated mobile device, according to various embodiments;

FIG. 2 is an illustration of a video capture interface, according to various embodiments;

FIG. 3 is an illustration of a video capture interface with an alternate aspect ratio, according to various embodiments;

FIG. 4A is an illustration of a video editing home screen interface with an active video file at the beginning of the video, according to various embodiments;

FIG. 4B is an illustration of a video editing home screen interface with an active video file at the end of the video, according to various embodiments;

FIG. 5 is an illustration of a cropping interface, according to various embodiments;

FIG. 6A is an illustration of a supplemental text interface including an overlay window control, according to various embodiments;

FIG. 6B is an illustration of a supplemental text interface displaying dragged text locations, according to various embodiments;

FIG. 6C is an illustration of a supplemental text interface demonstrating use of the overlay window control, according to various embodiments;

FIG. 7A is an illustration of a supplemental audio interface including an audio outline bar, according to various embodiments;

FIG. 7B is an illustration of a supplemental audio interface including an audio outline bar with an adjusted overlay window, according to various embodiments;

FIG. 7C is an illustration of a supplemental audio interface including an audio outline bar with a narrowed overlay window, according to various embodiments;

FIG. 7D is an illustration of a supplemental audio interface including a playback progress bar with a shifted overlay window, according to various embodiments;

FIG. 8 is an illustration of a supplemental audio interface including a plurality of audio outline bars, according to various embodiments;

FIG. 9 is an illustration of an audio recording interface, according to various embodiments;

FIG. 10 is a flowchart of a method for a multi-interface video editing application; and

FIG. 11 is a flowchart of a method for a multi-interface video editing application including alternate editing interfaces.

### DETAILED DESCRIPTION

Embodiments of the invention comprise a touchscreen-enabled, processor-operated mobile device program for editing video files, wherein primary editing functions are operated by a user, each from a single interface.

For the purposes of this disclosure, the phrase “touch interaction” describes interaction between a user's fingers, or hand, with reference to digital/virtual objects. In some embodiments, this involves the contact of one or more fingers with a physical touchscreen in motions described as tapping, pressing, long-pressing, holding, dragging, swiping, pinching, zooming, swirling, drawing, or other suitable contact known in the art. In other embodiments, touch interaction comprises the above list of motions conducted in open space wherein interface projections are displayed to a user such as with an augmented reality headset.

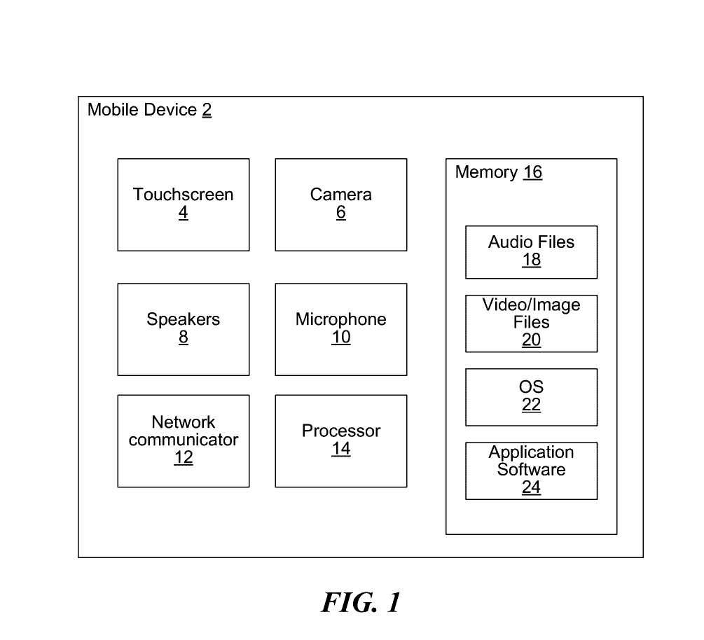

FIG. 1 is a block diagram of a touchscreen-enabled, processor-operated mobile device 2, according to various embodiments. In some embodiments, the mobile device 2 includes multiple components. These components include a touchscreen 4, at least one camera 6, speakers 8, a microphone 10, a network communicator 12, a processor 14, and a memory 16.

Illustrative examples of a preferred mobile device 2 include the iPhone smartphones and iPad tablets marketed by Apple, Inc. of Cupertino, Calif.; the Galaxy S smartphone and Galaxy Tab tablet marketed by Samsung Electronics, Co., Ltd. of Suwon, South Korea; the Yoga Pro 2-in-1 hybrid marketed by Lenovo Group, Ltd. of Beijing, China; or other suitable smartphones, tablets, 2-in-1 laptop/tablet hybrids, or augmented reality device known in the art.

The touchscreen 4 provides at least a first means for user interaction and control of the mobile device 2. In some embodiments, the touchscreen 4 comprises a physical screen that a user physically taps, drags, or presses against for control. In other embodiments, the touchscreen 4 is an augmented reality projected image that the user views and manipulates with hand gestures captured by a camera.

The camera 6 captures video data or image data for use by the application. The speakers 8 emit sound for the mobile device 2. The microphone 10 records ambient audio for the mobile device 2. The network communicator 12 connects the mobile device 2 to outside networks such as the Internet or telephonic networks.

The memory 16 stores numerous digital components such as audio files 18, video and image files 20, an operating system 22, and application software 24. Examples of operating systems 22 include iOS, Android, Windows Mobile, Windows 8, or any other suitable operating system known in the art.

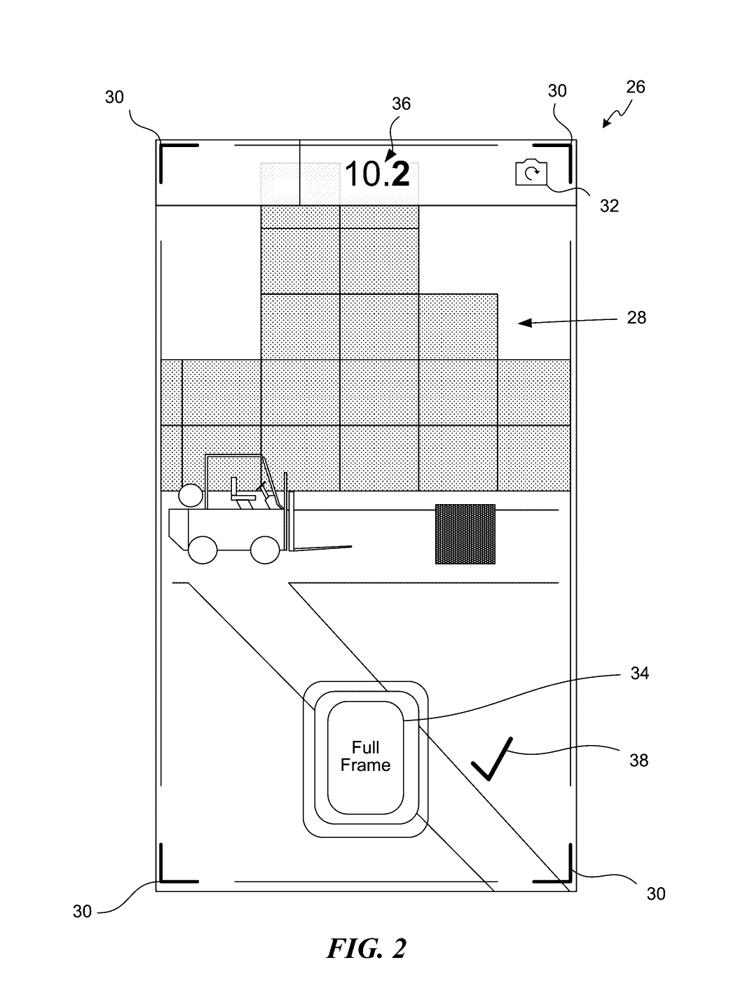

FIG. 2 is an illustration of a video capture interface 26, according to various embodiments. The video capture interface 26 is a view finder 28 limited by aspect ratio brackets 30. The view finder 28 displays data captured by the camera 6. In the example displayed in FIG. 2, the view finder 28 includes a forklift in a warehouse. In some embodiments, the video capture interface 26 includes a camera swap button 32. The camera swap button 32 changes the direction from which camera 6 of the mobile device 2 collects video or image data in mobile devices 2 with multiple cameras 6.

The video capture interface 26 further includes a record button 34. The record button 34 is tapped or pressed by a user of the mobile device 2 to record video data 20. In some embodiments, recording the video data 20 is configured to be stopped and started based on whether or not a user is holding down the record button 34. The record button 34 displayed in FIG. 2 additionally describes the aspect ratio of the view finder 28.

The video capture interface 26 additionally includes a recording length bar 36 which displays the length of time existing in a user's current recording of video data 20. When the user is finished recording, the user selects the finished recording button 38.

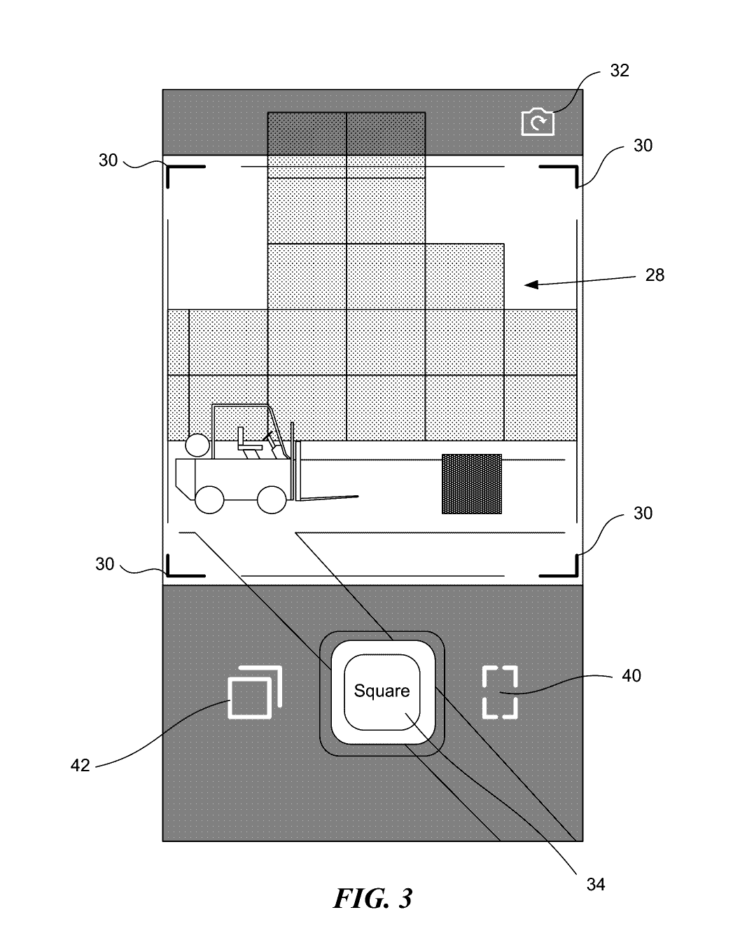

FIG. 3 is an illustration of a video capture interface 26 with an alternate aspect ratio, according to various embodiments. In FIG. 3, an aspect ratio button 40 has been pressed which adjusts the aspect ratio of the view finder 28. Accordingly, the record button 34 has changed to describe the new aspect ratio. The aspect ratio button 40 is present in the video capture interface before recording has commenced. Additionally, in mobile devices 2 that are orientation aware, altering the orientation of the mobile device 2 can alter the aspect ratio.

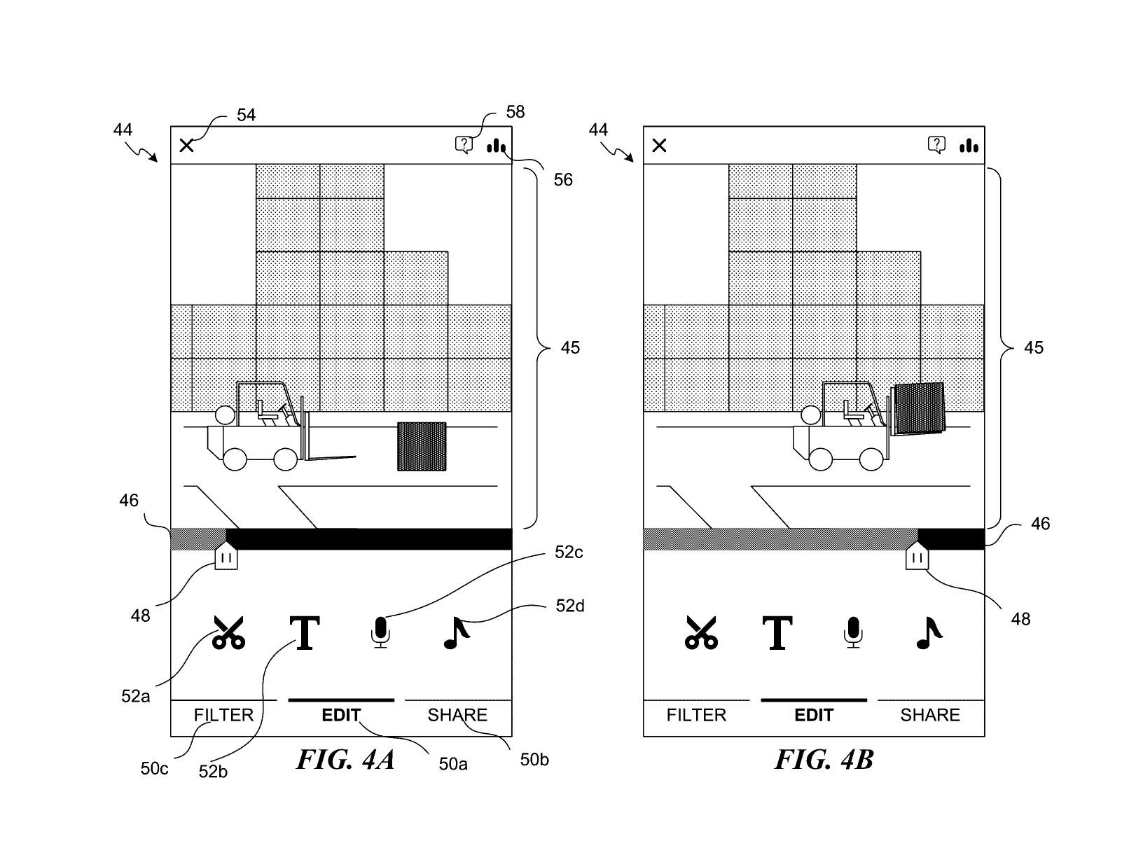

Additionally included in some embodiments of the video capture interface 26 is an import video button 42. Activating the import video button enables a user to import video data 20 from storage locations external to the application 24. Such external locations include mobile device memory 16, or communications networks such as the Internet. FIG. 4A and FIG. 4B are illustrations of a video editing home screen interface 44 with active video data 20, according to various embodiments. In some embodiments, the home screen includes a playback screen 45 wherein video data 20 continues a looping play-through. For illustrative purposes, the video data 20 displayed in the figures of this application comprises a thirty-second video of a forklift driving left to right in a warehouse to pick up a crate. Video data 20 can comprise any audio-visual content.

Additionally included on the home screen interface 44 is a playback progress bar 46 including a playback head 48 for indicating current location in the playback of video data 20. FIG. 4A displays the playback head 48 near the beginning of the video data 20, and FIG. 4B displays the playback head 48 near the end of the video data 20.

In some embodiments, the home screen interface 44 includes high level controls 50. Examples of high level controls 50 are an editing pane 50A, a share pane 50B, and a filter pane 50C. Each high level control 50 cycles through a set of relevant interface controls. In FIGS. 4A and 4B, the editing pane 50A is selected.

In some embodiments, the editing pane 50A of the home screen interface 44 includes editing interface buttons 52. The editing interface buttons 52 transfer the user to new screens dedicated to editing a particular feature of the video data 20. Displayed in FIGS. 4A and 4B are four such buttons including a cropping interface button 52A, a supplemental text interface button 52B, an audio recording interface button 52C, and a supplemental audio interface button 52D. Other editing interface buttons 52 are available as well.

In some embodiments, returning to the home screen interface 44 from the new screens dedicated to editing particular features of the video data 20 will update the video data 20 with the changes made at the new screens.

On the share pane 50B, a number of control buttons enable the user to share the video data 20 looping on the playback screen 45. Sharing includes, but is not limited to, sending by email, uploading to a chosen website, sharing to a particular user or group of users on a social media network, and transmitting via MMS protocol. On the filter pane 50C, the user is enabled to apply one or more photo effect filters to the video data 20.

In some embodiments, the home screen interface 44 further includes additional controls, including discard button 54, mute button 56, developer feedback button 58, or other suitable controls known in the art. The discard button 54 discards the active video data 20 or saves it to a local memory 16 on the mobile device 2. Use of the discard button 54 requires users to record or import new video data in order to proceed. The mute button 56 is configured to mute the audio of the original video data file. Supplemental audio files 18 added to the video data 20 will continue to play as selected.

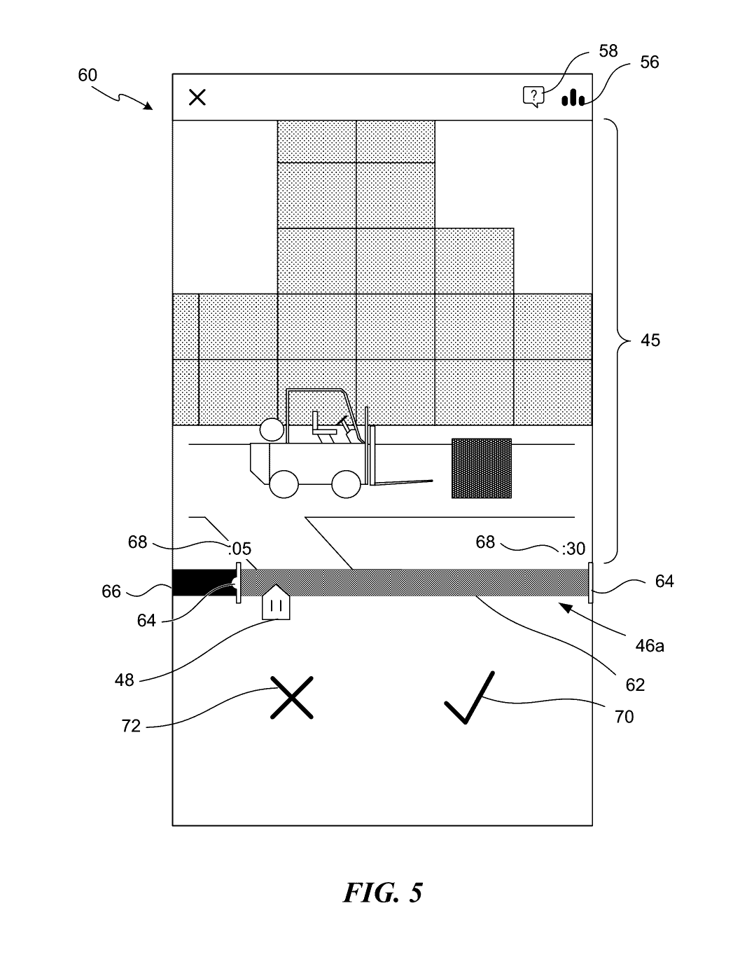

FIG. 5 is an illustration of a cropping interface 60, according to various embodiments. In some embodiments, the cropping interface 60 is accessed when a user presses the cropping interface button 52A from the home screen interface 44. The cropping interface 60 enables a user to snip off portions of the video data 20. FIG. 5 displays a user selecting to remove the first 5 seconds of the video data 20.

In some embodiments, cropping decisions are made using the cropping playback progress bar 46A. A user selects an active video segment 62 by touch interaction with toggle tabs 64 located at either end of the active video segment 62 and dragging the toggle tabs 64 to the right or left. Shortening the video data 20 leaves dead space 66 which are portions of the original video data that are no longer included in updated versions of the video data 20. Additionally displayed are time notions 68 which provide users with detailed information about how much of the video data 20 is selected.

Various embodiments further enable the user to drag the active video segment 62 right or left. Accordingly, the active video segment is an overlay on the cropping progress bar 46A that displays a window of selected video data 20. The active video segment 62 can similarly be referred to as a progress bar overlay window. Various embodiments of progress bar overlay windows are disclosed herein.

Moving the active video segment 62 right or left adjusts the unselected dead space 66. Returning to the example of FIG. 5, touch interaction anywhere along the active video segment 62 with a right dragging motion shifts the 5 seconds of dead space 66 from the beginning to the end of the video data 20. Dragging the active video segment 62 back towards the left shifts some or all of the 5 seconds of dead space 66 back to the beginning of the video data 20. In some embodiments, while a user remains on the cropping interface 60, the active video segment 62 loops through on the playback screen 45 skipping the dead space 66.

When finished cropping, the user selects the accept button 70. The accept button 70 confirms the cropping and returns the user to the home screen interface 44. In some embodiments, returning to the cropping interface 60 after crops are made to the video data 20 enables a user to undo or make new crops to the video data 20. Accordingly, in these embodiments, amendments to video data 20 are stored as metadata rather than saving a new version of the video data 20. In these embodiments, new video files are not saved until a final version of the video data 20 is either saved locally or exported/shared.

Additionally on the cropping interface 60 is a reject edits button 72. The reject edits button 72 reverses any changes made on the cropping interface 60.

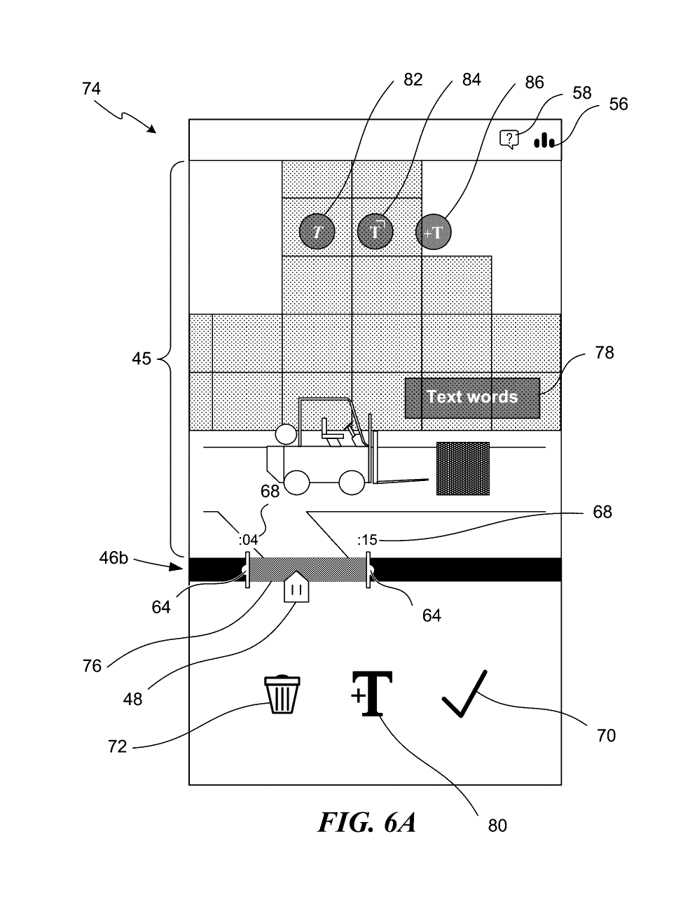

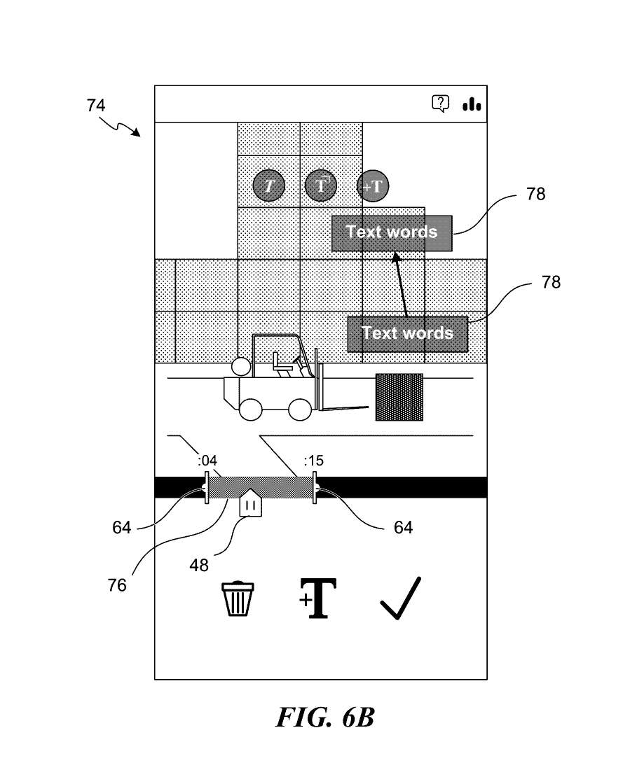

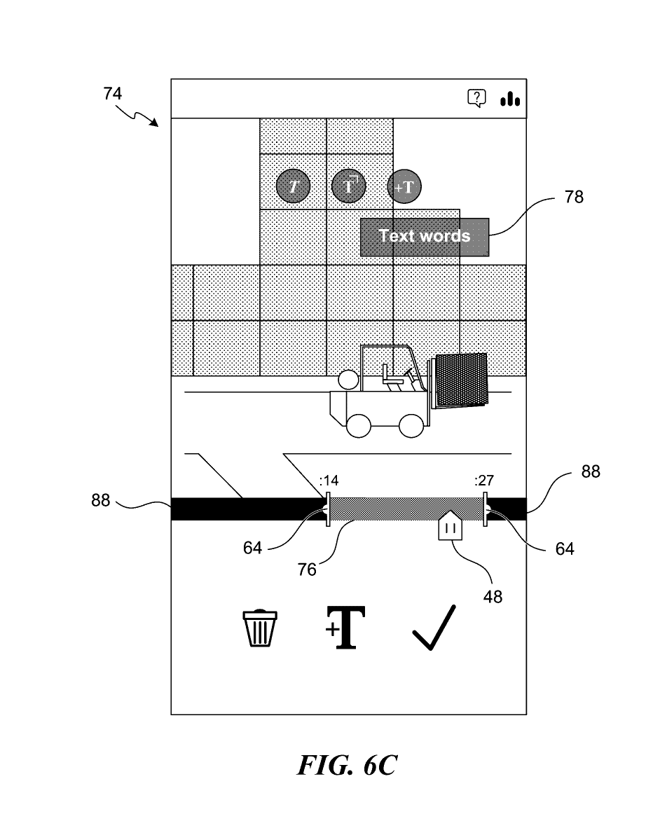

FIG. 6A is an illustration of a supplemental text interface 74 including an overlay window control 76, according to various embodiments. The supplemental text interface 74 is used to add text overlays 78 to the video data 20. This process is initiated when a user selects the new text button 80. Pressing the new text button 80 brings up a prompt wherein the user is enabled to enter text. In FIG. 6A, this text is represented by the phrase “text words” as displayed in the playback screen 45. Multiple uses of the new text button 80 generate multiple text overlays 78. Each text overlay 78 is controlled individually and selected by touch interaction on the text overlay 78.

There are numerous controls for text overlays 78. Displayed as floating buttons on the display screen 45, these controls include a font button 82, a background button 84, and a text size button 86. Pressing each of these buttons 82, 84, 86 cycles through a number of options for the selected text overlay 78.

FIG. 6B is an illustration of a supplemental text interface 74 displaying dragged text locations, according to various embodiments. Touch interaction with text overlays 78 on the display screen 45 enables a user to drag the visual location of the text overlay 78 as displayed during playback of the video data 20.

FIG. 6C is an illustration of a supplemental text interface 74 demonstrating use of the overlay window control, according to various embodiments. Similar to the cropping interface 60, the supplemental text interface 74 includes a text editing playback progress bar 46B. The supplemental text interface 74 additionally includes a progress bar overlay window 76 corresponding to each text overlay 78. Touch interaction with toggle tabs 64 on either side of the progress bar overlay window 76 increases the length of time the text overlay 78 is presented to viewers of the video data 20 between the entire length of the video and a period of time greater than zero seconds.

Shown in FIGS. 6A and 6B, an eleven-second period of time is selected. In FIG. 6C, a thirteen-second period of time is selected. In some embodiments, playback looping on the playback screen 45 occurs only for the length of time selected by the playback progress bar overlay window 76 corresponding to the selected text overlay 78. When the playback progress bar overlay windows 76 of multiple text overlays 78 overlap, then multiple text overlays 78 will exist in the looping playback of the video data 20 of the selected text overlay 78. In other embodiments, the playback loop of the video data 20 on the display screen 45 occurs for the entirety of the video data.

Touch interaction with the playback progress bar overlay window 76 enables a user to shift the temporal location of display for the selected text overlay 78. As shown between FIGS. 6B and 6C, the playback progress bar overlay window 76 has been dragged right to begin ten seconds later in the video data 20. The remaining space 88 has no text overlay 78 displayed during playback of the video data 20. When the length of the progress bar overlay window 76 is the same length as the video data 20, there is no remaining space 88.

Additionally included on the supplemental text interface 74 is an accept edits button 70 and a reject edits button 72.

In some embodiments, a user is enabled to change the size and orientation of text overlays 78 through touch interaction. In other embodiments, rather than text, a user is enabled to add in images, “stickers,” clipart, or .GIF files.

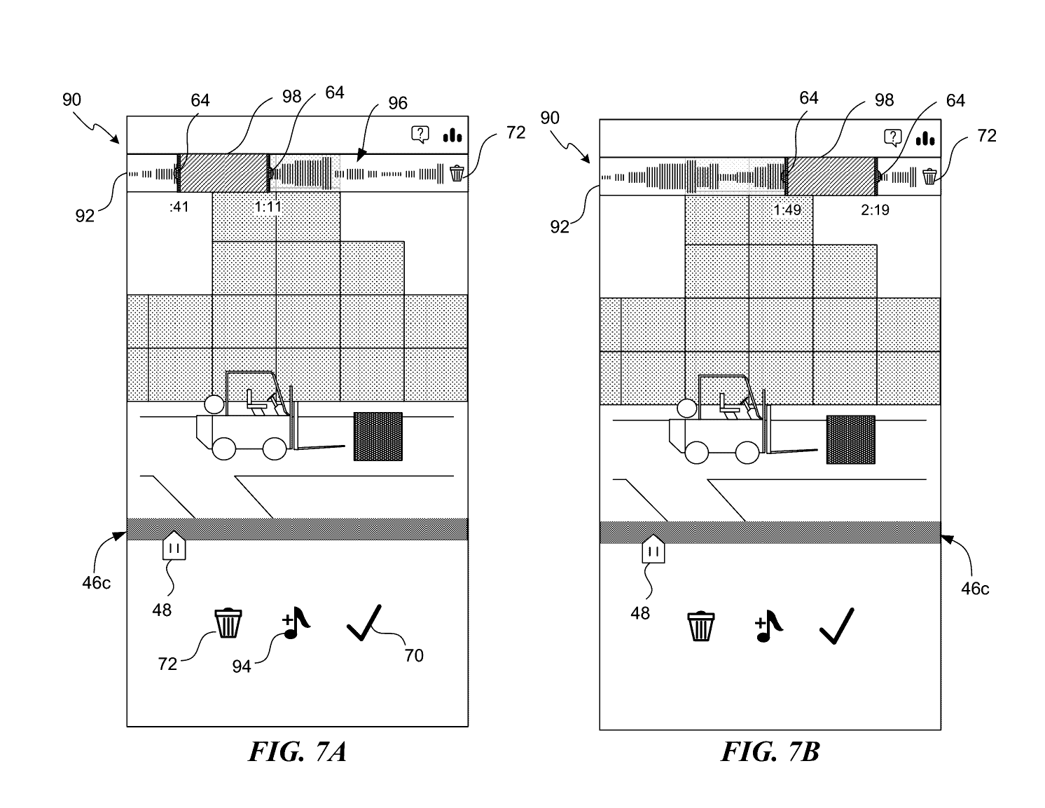

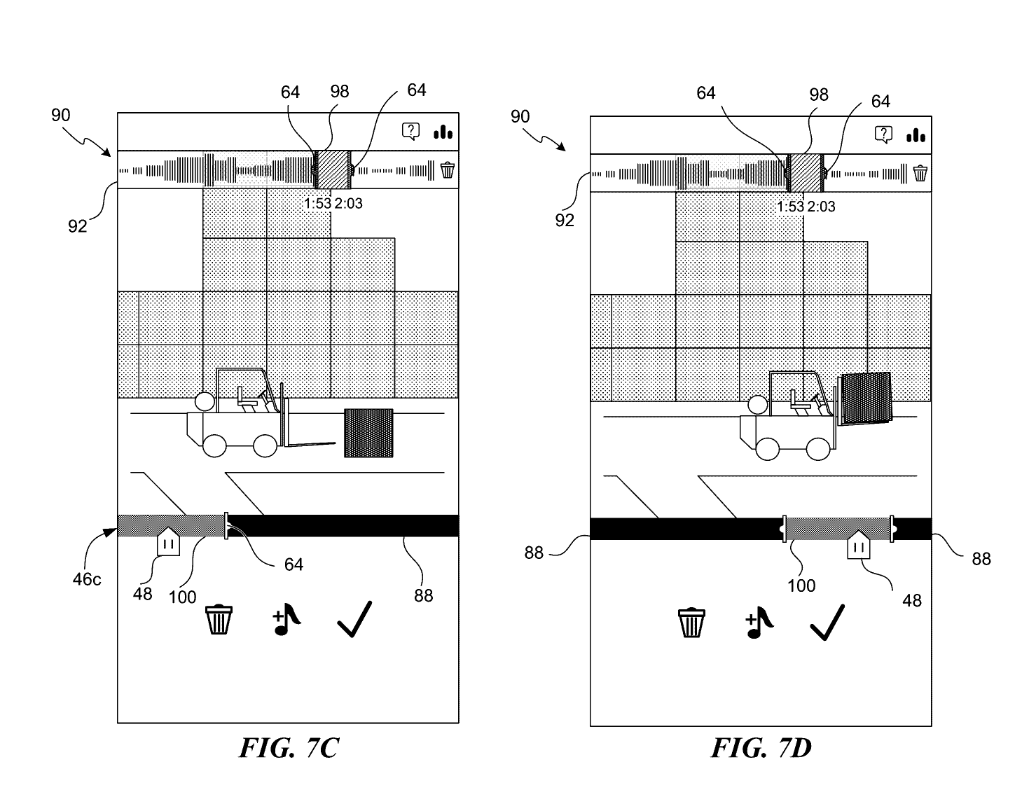

FIG. 7A is an illustration of a supplemental audio interface 90 including an audio outline bar 92, according to various embodiments. The supplemental audio interface 90 is used to add audio data such as songs to video data 20. This process is initiated when a user selects the new audio button 94. Pressing the new audio button 94 brings up a new screen wherein the user is enabled to select audio files 18 stored locally on the mobile device 2. Selecting an audio file 18 generates an audio outline bar 92.

The audio outline bar 92 includes a profile of audio levels 96 throughout a selected audio file 18. Multiple uses of the new audio button 94 generate multiple audio outline bars 92. Each audio outline bar 92 is controlled individually and selected by touch interaction. Each audio outline bar 92 further includes an outline overlay window 98.

In FIG. 7A the outline overlay window 98 includes a thirty-second portion of the audio file 18. The sample audio file 18 in FIG. 7A is notably longer than thirty seconds. Other audio files 18 are of varying length and thus thirty seconds takes up a greater or smaller percentage of the whole. Also depicted in FIG. 7A is an audio edits playback progress bar 46C. The audio edits playback progress bar 46C includes no remaining space 88 as a result of the video data 20 being thirty seconds long and the portion of the audio file 18 selected by the outline overlay window 98 also being thirty seconds long.

FIG. 7B is an illustration of a supplemental audio interface 90 including an audio outline bar 92 with an adjusted outline overlay window 98, according to various embodiments. Through touch interaction, a user drags the outline overlay window 98 either left or right along the audio outline bar 92 to adjust the selected portion of the audio file 18. Between FIGS. 7A and 7B, the outline overlay window 98 has been moved so the selected portion of the audio file 18 begins at 1:49, rather than at 0:41 of the audio file 18.

FIG. 7C is an illustration of a supplemental audio interface 90 including an audio outline bar 92 with a narrowed outline overlay window 98, according to various embodiments. The outline overlay bar 98 includes toggle tabs 64 as with other overlays 62, 76. Through touch interaction, the toggle tabs 64 adjust the length of the selected portion of the audio file 18 and the outline overlay window 98.

Shown between FIGS. 7B and 7C, the length of the outline overlay window 98 has been reduced from thirty seconds to ten seconds. This reduction in outline overlay window 98 size has in turn shortened the progress bar overlay window 100. As a result of the progress bar overlay window 100 being no longer as long as the video data 20, there is remaining space 88 on the audio edit playback progress bar 46C.

Shown in FIG. 7C, toggle tabs 64 exist on both the outline overlay window 98 and the progress bar overlay window 100. In some embodiments, the toggle tabs 64 only exist on either the outline overlay window 98 or the progress bar overlay window 100. Accordingly, the length of a given overlay window 98, 100 varies directly with the length of the opposing overlay window 98, 100 and is not adjustable directly.

Because a given audio file 18 may vary greatly in length compared to the video data 20, selection of the toggle tabs 64 for the outline overlay window 98 can exhibit a granularity issue. To address this issue, in some embodiments, the length of the outline audio overlay 98 is adjustable with toggle tabs 64 associated with the progress bar overlay window 100. In various embodiments, touch interaction on the audio outline bar 92 zooms the audio outline bar 92 in or out making selection of the toggle tabs 64 easier. Examples of such touch interaction include long presses, multi-taps, multi-touch expanding or multi-touch contracting, or any other suitable touch object control known in the art. In various embodiments, the granularity issue is addressed by expanding the size of the toggle tabs 64.

FIG. 7D is an illustration of a supplemental audio interface 90 including an audio playback progress bar 46C with a shifted progress bar overlay window 100, according to various embodiments. Between FIGS. 7C and 7D, a user has shifted the progress bar overlay window 100 from the beginning of the video data 20 to the end of the video data 20.

As depicted by FIGS. 7A-7D, a user is enabled to select both the length and portion of an audio file 18 and have that length and portion of the audio file 18 playback during a selected length and segment of the video data 20, all on the same screen.

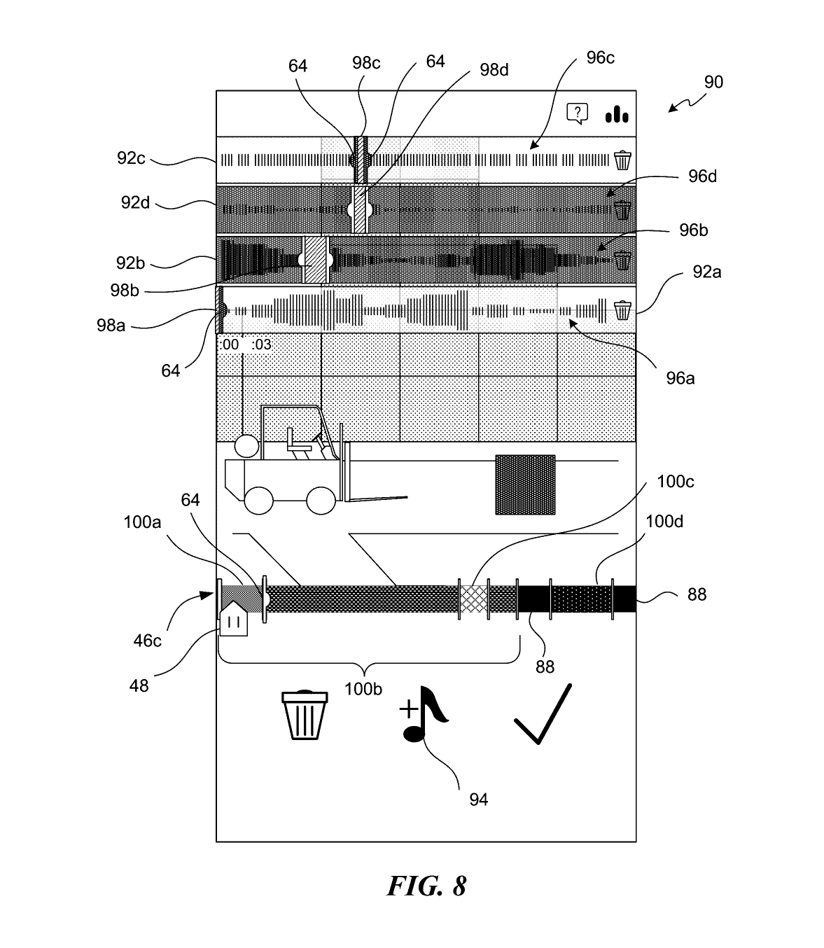

FIG. 8 is an illustration of a supplemental audio interface 90 including a plurality of audio outline bars 92A-92D, according to various embodiments. When the new audio button 94 is used multiple times, a plurality of audio outline bars 92A-92D is generated on the supplemental audio interface 90 overlaying the playback screen 45. The audio outline bars 92A-92D have a degree of transparency so the video data 20 is at least partially visible through the audio outline bars 92. Each audio outline bar 92 corresponds to a given audio file 18. Each audio file 18 has an individual audio profile 96A-96D displayed within the audio outline bars 92A-92D.

The progress bar overlay windows 100A-100D are all placed on the same playback progress bar 46C. In some cases, the progress bar overlay windows 100A-100D overlap. As depicted in FIG. 8, progress bar overlay window 100B is under both overlay windows 100A and 100C.

In FIG. 8, the selected audio outline bar for current editing is 92A and corresponding progress bar overlay window 100A. The currently selected portion of the audio file 18 associated with audio outline bar 92A is three seconds long. The outline overlay window 98A is used to edit the selected portion as described in the FIG. 7 series. To switch between which audio outline bar 92 is selected, a user employs touch interaction with another audio outline bar 92B-92D or another progress bar overlay window 100B-100D.

In some embodiments, the playback head 48 will loop through only the selected segment of the video data 20 as indicated by the currently selected progress bar overlay window 100A. In other embodiments, the playback head 48 will loop through all progress bar overlays 100A-100D. In still other embodiments, the playback head 48 will loop through the entire playback progress bar 46C, including all progress bar overlay windows 100A-100D and remaining space 88.

A user is thereby enabled to select portions from multiple songs to play at selected segments of video data 20, all from a single screen.

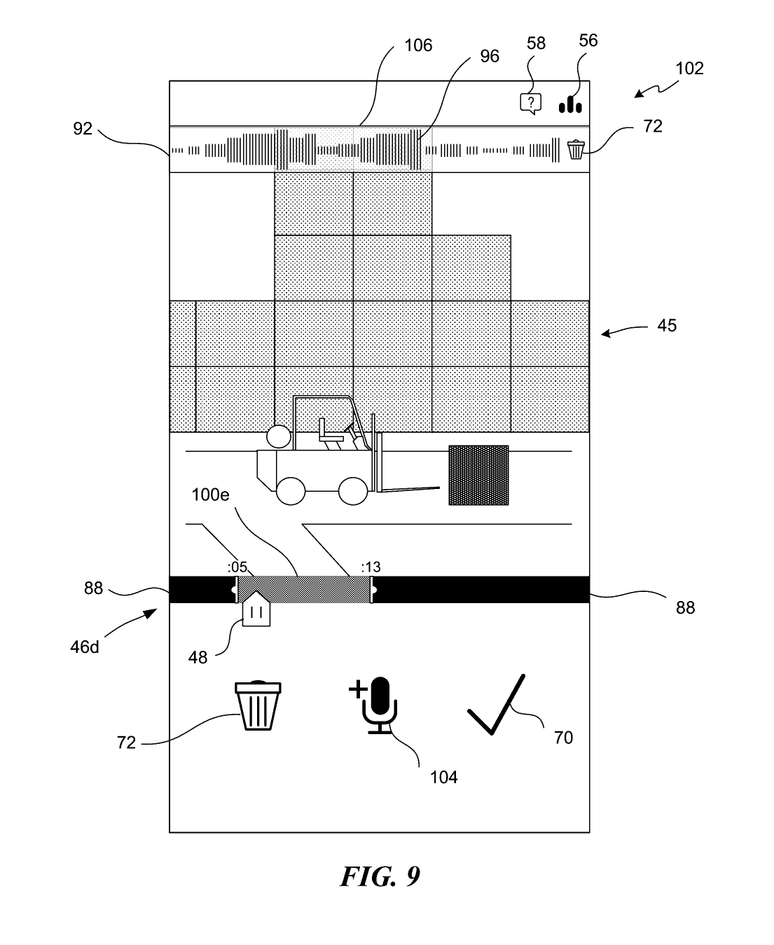

FIG. 9 is an illustration of an audio recording interface 102, according to various embodiments. The audio recording interface 102 operates very similarly to the supplemental audio interface 90, the primary difference being when the record new audio button 104 is pressed, as opposed to the new audio button 94, the microphone 10 of the mobile device 2 is triggered to record ambient sound. Then an audio outline bar 92 is created with a corresponding audio profile 96 to the recorded ambient sound.

FIG. 9 depicts the lack of an outline overlay window 92. The function of the audio recording interface 102 is not interrupted by this missing element 98, though, in some embodiments, the audio recording interface 102 includes an outline overlay window 98.

The remaining elements of the audio recording interface 102 function similarly to previously introduced elements such that FIG. 9 is self-explanatory.

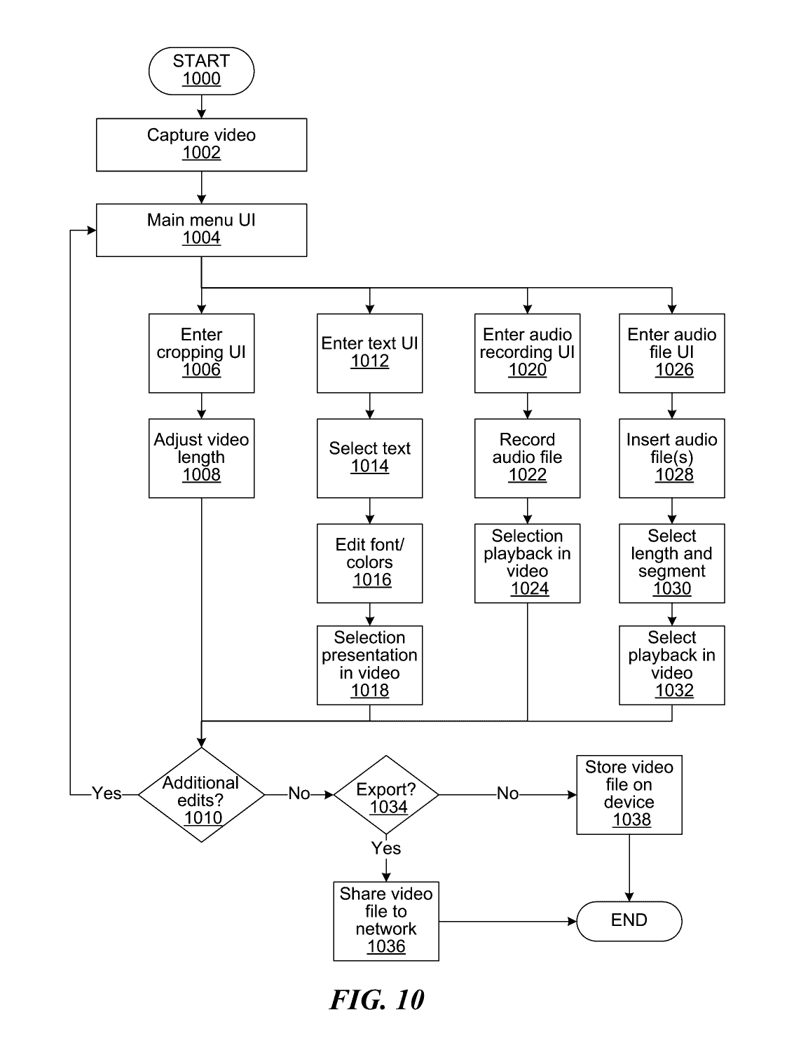

FIG. 10 is a flowchart of a method for a multi-interface video editing application, according to various embodiments. In step 1002, the user captures video to a mobile device 2. This step includes options such as aspect ratio, camera used, and length of recording. In some embodiments, the video capture function is a point-and-capture system. In other embodiments, the video is uploaded to the mobile device 2 from an external source. In still other embodiments, the mobile device is programmed to repeatedly capture a predetermined period of time and hold that amount of video stored. A user is then enabled to begin active recording via point and capture wherein the final recording will comprise the point-and-capture recording with the additional predetermined period of time of recording preceding the point-and-capture recording.

In step 1004, the application pushes the user to the home screen interface 44. From this screen the user is presented with a plurality of options for editing.

In step 1006, the application directs a user to the cropping interface 60. In step 1008, the application then enables the user to adjust video length. After the application receives approval from the user, in step 1010, the user decides if additional edits are desired. When yes, then the application presents the home screen user interface 44, and the user is prompted to choose another means for editing.

In step 1012, the application directs a user to the supplemental text interface 74. In step 1014, the application enables the user to enter text. In step 1016, the application enables the user to edit the font, color, orientation, and position of the text through toggles and controls operated through touch interaction. In step 1018, the application enables the user to choose temporal location for display of the text.

In step 1020, the application directs a user to the audio recording interface 102. In step 1022, the application enables the user to record audio. In step 1024, the application enables the user to choose temporal location of the recorded audio through controls operated through touch interaction.

In step 1026, the application directs a user to the supplemental audio interface 90. In step 1028, the application enables the user to select audio files and import them into the application. In step 1030, the application enables the user to select the portion and length of the audio to play back during the video.

In step 1032, the application enables a user to choose temporal location during the video to play back the portion of the audio. The application further enables users to control music volume by providing a toggled volume bar applied to the selected audio file 18. Users are further enabled to fade in and fade out a music sound track when it is added to video data 20.

In step 1034, once there are no additional edits, the application enables the user to export the edited video file to an external network as shown in step 1036. In step 1038, when the user chooses not to export the video, the video is saved locally on the mobile device 2.

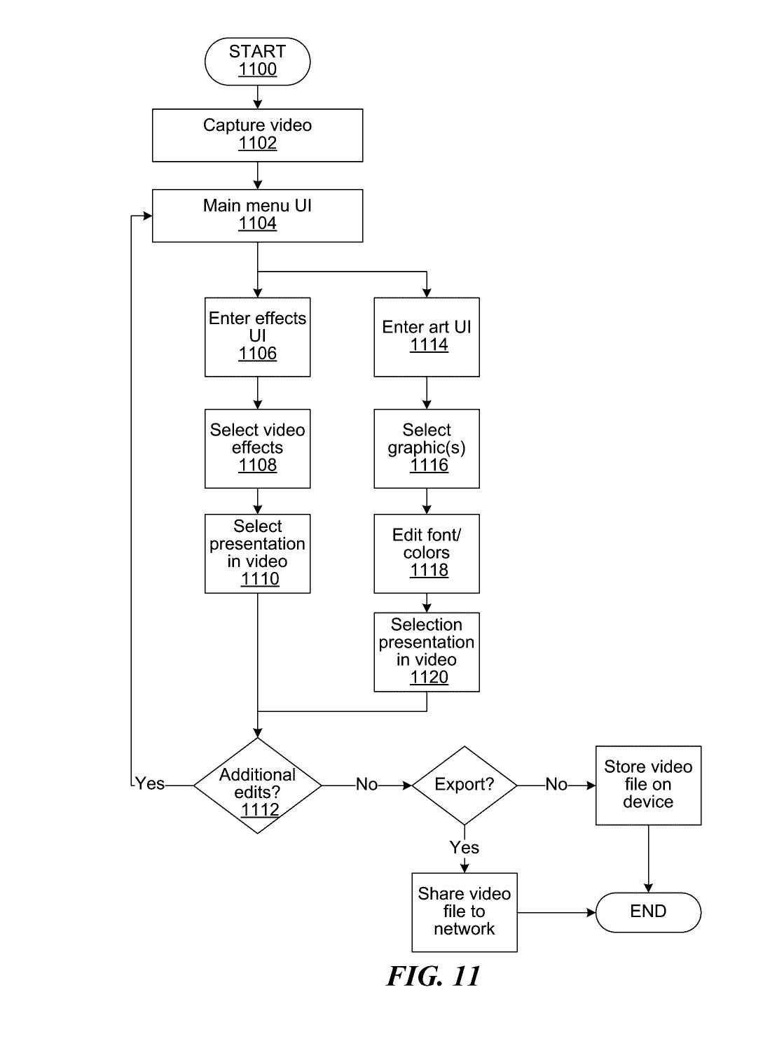

FIG. 11 is a flowchart of a method for a multi-interface video editing application including alternate editing interfaces, according to various embodiments. The method displayed in FIG. 11 is similar to that displayed in FIG. 10. The primary differences are exhibited in interface screen processes 1106-1110, and 1114-1120. Accordingly, these are the only segments of the method included in the continued discussion.

In step 1106, the application enables the user to select video effects to apply. In step 1108, the application presents effects the user is enabled to select. Examples of video effects include: time-scoped filter, meaning a filter will apply to a segment of video, similar to how a text applies to a segment of video; and region-scoped filter, meaning a filter will apply to a specific area of videos.

In step 1110, the application enables the user to select the look and feel of the presentation of the effects. In some embodiments, the filter area is selected by user's touch interaction, for example, a pixelate/mosaic is applied to a small area of the video, or a color is applied to an area of a black/white video. When camera 6 is enabled to recognize regions/depths such as with light-field cameras, the user is enabled to apply filters to specific depth profiles, such as sending the background into black/white while the foreground stays in color, merely by selecting the effect and tapping on the background.

In step 1114, the application enables the user to enter an interface to select art to apply. In step 1116, the application enables the user to draw on the screen through touch interaction, or import images and animations from application external sources. In step 1118, the user is enabled to amend the color of the image or animation drawn or imported. In step 1120, the application enables the user to choose temporal location of the recorded audio via controls operated through touch interaction.

1. A method for operating an application on a touchscreen enabled, processor operated mobile device for improving the ease of editing video files, the application including a home screen enabling a user to access several editing suites, each editing suite comprising a single interface screen, comprising:
causing a video recording device to capture video data;
displaying, on the touchscreen, a first editing suite, the first editing suite including a first playback progress bar associated with the video data, wherein an interactive element of the first playback progress bar enables a user to adjust the length of the video data by dragging an end of the first playback progress bar through touchscreen interaction;
displaying, on the touchscreen, a second editing suite, the second editing suite comprising:
a playback screen associated with displaying the video data;
a playback progress bar associated with the video data; and
a text insertion button;
the second editing suite providing a user functionality, including:
enabling selection of text with the touchscreen through selection of the text insertion button;
enabling selection via touch interaction with the playback progress bar a portion of the video file which to incorporate the text;
enabling the repositioning of the text on the playback screen through touch interaction;
displaying on the touchscreen, a third editing suite, the third editing suite comprising:
the playback screen associated with displaying the video data;
the playback progress bar associated with the video data;
an audio file insertion button; and
an audio file outline bar:
enabling import of an audio file external to the application through selection of the audio file insertion button;
enabling selection via touch interaction with the audio file outline bar a segment of the audio file which to incorporate into the video data;
enabling selection via touch interaction with the playback progress bar a portion of the video file which to incorporate the segment of the audio file; and
generating an augmented video file based on the touchscreen interaction on the first editing suite, the second editing suite, and the third editing suite.

2. The method of claim 1, further comprising:
displaying on the touchscreen, a fourth editing suite, the fourth editing suite comprising:
the playback screen associated with displaying the video data;
the playback progress bar associated with the video data;
an audio file recording button; and
a recorded audio file outline bar:
enabling recording of ambient audio through selection of the audio file recording button; and
enabling selection via touch interaction with the playback progress bar a portion of the video file which to incorporate the ambient audio.

3. The method of claim 1, further comprising:
displaying, on the touchscreen, a fourth editing suite a playback progress bar, and an effects insertion button, the effects insertion button enabling the user to select video effects to apply during playback of the video data, further touchscreen interaction with the fourth editing suite comprising:
generating an overlay associated with the effects to apply, the overlay positioned atop the playback progress bar;
enabling the user to relocate and resize the third overlay with respect to the playback progress bar through touchscreen interaction; and
determining the playback time and length of playback for the effects with respect to the video data based on said relocation and said resizing of the overlay respectively.

4. The method of claim 1, further comprising:
exporting the augmented video file with a network communicator to the Internet.

5. A method for combining video data with supplemental audio data on a mobile device with a touchscreen, comprising:
providing a touchscreen graphic user interface (GUI), the touchscreen GUI comprising:
a playback screen associated with displaying the video data;
a playback progress bar associated with the video data;
an audio file insertion button; and
an audio file outline bar:
enabling import of an audio file external to the touchscreen GUI through selection of the audio file insertion button;
enabling selection, via touch interaction with the audio file outline bar, of a segment of the audio file which to incorporate into the video data;
enabling selection via touch interaction with the playback progress bar a portion of the video file which to incorporate the segment of the audio file; and
combining the segment of the audio file with the video file at the portion of the video file into a combined media file.

6. The method of claim 5, further comprising:
storing the combined media file in a memory.

7. The method of claim 5, further comprising:
enabling import of additional audio files external to the touchscreen GUI through selection of the audio file insertion button;
generating additional audio file outline bars for each additional audio file imported;
enabling selection via touch interaction with each additional audio file outline bar of a segment of each of the additional audio files which to incorporate into the video data;
enabling selection via touch interaction with the playback progress bar one or more respective segments of the video file which to incorporate each of the segments of each of the additional audio files;
combining each of the segments of each of the additional audio files with the video file at the respective segments of the video file into a combined media file.

8. The method of claim 5, further comprising:
providing a looping playback of at least a portion of the combined media file to preview selections via touch interaction.

9. The method of claim 5, wherein said selection via touch interaction with the audio file outline bar comprises adjusting an outline overlay in position to select the segment of the audio file, the outline overlay positioned atop the audio outline bar and the segment of the audio file selected by the outline overlay.

10. The method of claim 9, wherein said selection via touch interaction with the playback progress bar comprises adjusting a progress bar overlay in both position and length to select the portion of the video file, the length of the progress bar overlay adjusting the length of the outline overlay, and the progress bar overlay positioned atop the playback progress bar and the portion of the video file selected by the progress bar overlay.

11. The method of claim 5, the touchscreen GUI, further comprising:
a mute toggle button enabled to mute audio associated with the video file.

12. The method of claim 5, wherein all occurrences of touch interaction comprises at least one of described motions detected on the touchscreen: tapping, pressing, long-pressing, holding, dragging, swiping, pinching, zooming, swirling, drawing.

13. The method of claim 5, wherein the audio file is imported from a song library on the mobile device.

14. The method of claim 5, further comprising:
recording the audio file by a microphone in or coupled to the mobile device.

15. The method of claim 5, further comprising:
extracting and importing the audio file from a video hosted on the Internet.

16. The method of claim 5, further comprising:
importing the video file from a video file hosted on the Internet.

17. The method of claim 9, wherein said enabling selection via touch interaction with the audio file outline bar a segment, wherein the audio file outline bar includes a granularity control, the granularity control enabling a user to zoom in an out of the audio file outline bar and alter the granularity of adjustments to the outline overlay.

18. A touchscreen enabled, processor operated mobile device, programmed to simultaneously present:
a frame of video data;
a playback screen associated with the video data;
a playback progress bar associated with the video data and includes a relative position indicator of the frame with the video data;
an audio file outline bar, corresponding to an audio file;
a progress bar overlay window positioned atop the playback progress bar and adjustable in position and width through touch interaction with the touchscreen and configured to select a portion of the video data corresponding to the position and the width of the progress bar overlay window;
an outline overlay window positioned atop the audio file outline bar and adjustable in position through touch interaction with the touchscreen and sized in width based upon the width of the progress bar overlay window and configured to select a segment of the audio file corresponding to the position and the width of the outline overlay;
wherein the playback screen plays back at least the portion of the video file inserting the segment of the audio file at the portion of the video file; and
a save button triggered through touch interaction and programmed to cause the segment of the audio file to be combined with the video file at the portion of the video file.

19. The touchscreen enabled mobile device of claim 18, wherein the processor is further programmed to present:
at least one additional audio file outline bar, corresponding to at least one additional audio file;
at least one additional progress bar overlay positioned atop the playback progress bar and adjustable in position through touch interaction and sized in width based upon the width of a corresponding outline overlay of the additional outline overlays and configured to each select an additional portions of the video file corresponding to the position of each of the additional progress bar overlays; and
additional outline overlays, each additional outline overlay corresponding to each additional audio file outline bar and adjustable in position through touch interaction and configured to each select additional segments of each of the additional audio files corresponding to the position of each of the additional outline overlays.

20. The touchscreen enabled device of claim 18, wherein the outline overlay includes a left side and a right side and further including a tab icon on the left side and the right side, wherein the tab icon is selectable by touch interaction with the touchscreen and enables a user to drag adjust the width of the outline overlay.

21. The touchscreen enabled device of claim 18, wherein the audio file outline bar includes a granularity control, the granularity control enabling a user to zoom in an out of the audio file outline bar and alter the granularity of adjustments to the outline overlay.

22. The touchscreen enabled device of claim 18, wherein all occurrences of touch interaction comprises at least one of described motions detected on the touchscreen: tapping, pressing, long-pressing, holding, dragging, swiping, pinching, zooming, swirling, drawing.

23. A method for combining video data with supplemental text data, comprising:
providing a touchscreen graphic user interface (GUI), the touchscreen GUI comprising:
a playback screen associated with displaying the video data;
a playback progress bar associated with the video data; and
a text insertion button;
enabling selection of text to the touchscreen GUI through selection of the text insertion button;
enabling selection via touch interaction with the playback progress bar a portion of the video file which to incorporate the text;
enabling the repositioning of the text on the playback screen through touch interaction; and
combining the text with the video file at the portion of the video file into a combined media file.

24. The method of claim 23, the touchscreen GUI, further comprising:
a font button;
a size button; and
a background button; and
wherein touch activation of the font button changes the font of the text, touch activation of the size button changes the size of the text, and touch activation of the background button changes a backdrop for the text.

25. The method of claim 23, wherein said repositioning includes rotating the text.

26. The method of claim 23, wherein said selection via touch interaction with the playback progress bar comprises adjusting a progress bar overlay in position and width to select the portion of the video file, the progress bar overlay positioned atop the playback progress bar and the portion of the video file selected by the progress bar overlay.

27. The method of claim 26, further comprising:
enabling selection of additional text to the touchscreen GUI through selection of the text insertion button; and
generating additional progress bar overlays for each additional text.

28. A method for combining video data with recorded audio data on a mobile device with a touchscreen, comprising:
providing a touchscreen graphic user interface (GUI), the touchscreen GUI comprising:
a playback screen associated with displaying the video data;
a playback progress bar associated with the video data;
an audio recording button; and
an audio file outline bar:
enabling recording of ambient audio through selection of the audio recording button;
enabling selection via touch interaction with the playback progress bar a portion of the video file which to incorporate the segment of the audio file; and
combining the segment of the audio file with the video file at the portion of the video file into a combined media file.

29. The method of claim 28, further comprising:
enabling recording of additional ambient audio through selection of the audio recording button;
generating additional audio file outline bars for each additional ambient audio recorded;
enabling selection via touch interaction with the playback progress bar one or more respective segments of the video file which to incorporate each of the additional ambient audio;
combining each of the each of the additional ambient audio with the video file at the respective segments of the video file into a combined media file.

30. The method of claim 5, further comprising:
providing a looping playback of at least a portion of the combined media file to preview selections via touch interaction.
